(19) United States
(12) Patent Application Publication
(10) Pub. No.: US 2021/0292559 A1
(43) Pub. Date: Sep. 23, 2021

(54) ADDITIVE MANUFACTURING METHOD AND ASSOCIATED ARTICLE

(71) Applicant: SABIC Global Technologies B.V., Bergen op Zoom (NL)

(72) Inventors: Sarah E. Grieshaber, Glenmont, NY (US); Steven Raymond Klei, Voorheesville, NY (US); Devendra Narayandas Bajaj, Mt Vernon, IN (US); Lanti Yang, Bergen op Zoom (NL)

(21) Appl. No.: 16/826,559

(22) Filed: Mar. 23, 2020

(51) Int. Cl. C08L 83/10; B29C 64/106; B33Y 10/00; B33Y 70/00; B29C 64/118; B33Y 80/00

(52) U.S. Cl. CPC C08L 83/10; B29C 64/106; B33Y 10/00; B33Y 70/00; B29K 2069/00; B33Y 80/00; C08L 2205/03; C08L 2205/025; B29C 64/118

(57) ABSTRACT

A method of additive manufacturing an article in the ZX (upright) orientation utilizes a composition including specific amounts of a polycarbonate-polysiloxane and polysiloxane-treated titanium dioxide particles. Although addition of titanium dioxide particles to a plastic composition typically reduces impact strength, articles additively manufactured from this composition exhibit improved impact strength relative to articles manufactured from a corresponding composition lacking the polysiloxane-treated titanium dioxide particles.

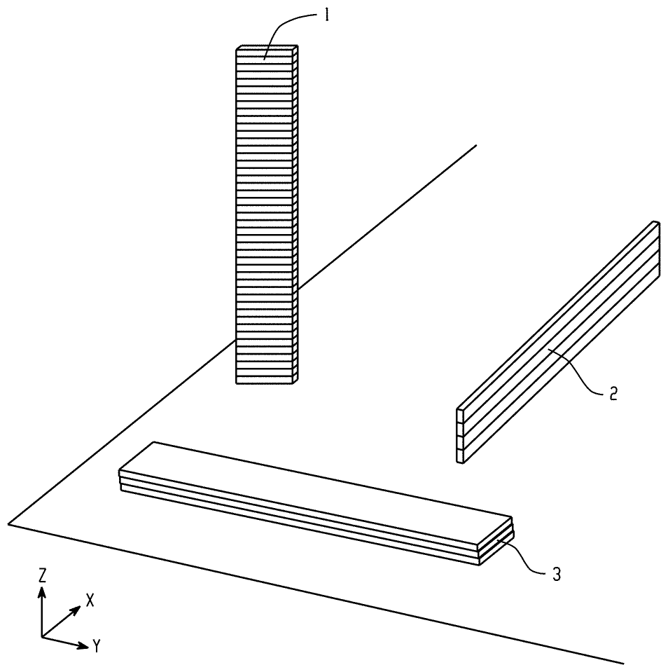

### BACKGROUND OF THE INVENTION

Using additive manufacturing, three-dimensional parts can be fabricated with layer-by-layer deposition or “printing” of a thermoplastic composition. The method utilizes a computer-controlled extrusion head to form a series of layers, each layer being formed by extrusion of a molten thermoplastic composition onto the underlying layer. As illustrated in the FIGURE, it is a convention of additive manufacturing that in a three-dimensional space defined by orthogonal X, Y, and Z axes, each layer is parallel to the XY plane, and the molten thermoplastic composition is deposited along the Z axis. In the FIGURE, three possible print orientations are named relative to the Z-direction (i.e., the direction along which material is deposited by the printer): the orientation labeled 1 has a ZX or “upright” orientation; the orientation labeled 2 has an XZ or “on-edge” orientation and; and the orientation labeled 3 has an XY or “flat” orientation. Articles printed in the ZX (upright) orientation typically exhibit significantly worse mechanical properties than articles printed in the XZ (on-edge) and XY (flat) orientations.

Titanium dioxide (TiO₂) is commonly used as a white colorant in thermoplastic compositions, including those used for additive manufacturing. However, addition of titanium dioxide in an amount effective for coloring usually adversely affects the mechanical properties of parts formed from the composition. There is therefore a critical need for materials and methods that improve the mechanical properties of parts additively manufactured in the ZX (upright) orientation with a thermoplastic composition containing titanium dioxide.

### BRIEF SUMMARY OF EMBODIMENTS OF THE INVENTION

One embodiment is a method of additively manufacturing an article in a ZX orientation, the method comprising: converting a composition from a solid form to a molten form; extruding the molten form to form a first molten extrusion; depositing the first molten extrusion in a predetermined pattern to form a first layer; further extruding the molten form to form a second molten extrusion; and depositing the second molten extrusion in a predetermined pattern to form a second layer having a lower surface in contact with an upper surface of the first layer; wherein the composition comprises, based on the total weight of the composition, 10 to 99 weight percent of a polycarbonate-polysiloxane; and 1 to 7.5 weight percent of titanium dioxide-containing particles comprising a polysiloxane.

Another embodiment is an article additively manufactured in a ZX orientation, the article comprising: at least two contiguous layers; wherein the at least two contiguous layers comprise a composition comprising, based on the total weight of the composition, 10 to 99 weight percent of a polycarbonate-polysiloxane; and 1 to 7.5 weight percent of titanium dioxide-containing particles comprising a polysiloxane.

These and other embodiments are described in detail below.

### BRIEF DESCRIPTION OF THE DRAWING

The FIGURE is an illustration of print (layer) orientations for exemplary test articles useful for determining mechanical properties.

### DETAILED DESCRIPTION OF THE INVENTION

The present inventors have determined that Z-direction impact strength is unexpectedly improved for parts additively manufactured in the ZX (upright) orientation from a polymer composition containing specific amounts of a polycarbonate-polysiloxane and titanium dioxide-based particles surface-treated with a polysiloxane. The improved Z-direction impact strength is observed for the polymer composition relative to corresponding compositions with less or none of the titanium dioxide-based particles surface-treated with a polysiloxane. Also, the improved Z-direction impact strength is not observed in parts printed in XZ (on-edge) or XY (flat) orientations, nor is it observed for compositions based on bisphenol A polycarbonate rather than polycarbonate-polysiloxane.

One embodiment is a method of additively manufacturing an article in a ZX orientation, the method comprising: converting a composition from a solid form to a molten form; extruding the molten form to form a first molten extrusion; depositing the first molten extrusion in a predetermined pattern to form a first layer; further extruding the molten form to form a second molten extrusion; and depositing the second molten extrusion in a predetermined pattern to form a second layer having a lower surface in contact with an upper surface of the first layer; wherein the composition comprises, based on the total weight of the composition, 10 to 99 weight percent of a polycarbonate-polysiloxane; and 1 to 7.5 weight percent of titanium dioxide-containing particles comprising a polysiloxane.

In the method, the article is additively manufactured in the ZX (upright) orientation. As discussed above, the ZX (upright) orientation is labeled “1” in the FIGURE. The method of additive manufacturing comprises converting a composition from a solid form to a molten form. In some embodiments, for example when the method comprises large format additive manufacturing, the solid form comprises pellets. In other embodiments, for example when the method comprises fused filament fabrication, the solid form comprises a filament.

The method further comprises forming successive layers from the molten form. Specifically, successive layers are formed by extruding the molten form to form a first molten extrusion, depositing the first molten extrusion in a predetermined pattern to form a first layer, further extruding the molten form to form a second molten extrusion, and depositing the second molten extrusion in a predetermined pattern to form a second layer having a lower surface in contact with an upper surface of the first layer. In some embodiments of the method, during deposition of the second layer, the upper surface of the first layer has a temperature 20 to 200° C. above the glass transition temperature of the composition. Within this temperature range, the upper surface of the first layer can have a temperature 50 to 200° C., or 50 to 150° C. above the glass transition temperature of the composition.

In some embodiments, the method further comprises repeating the extruding and depositing steps at least three times, or at least five times, or at least ten times to produce the article.

The method utilizes a composition comprising specific amounts of a polycarbonate-polysiloxane and titanium dioxide-containing particles comprising a polysiloxane. A polycarbonate-polysiloxane is a polymer comprising at least one polycarbonate block and at least one polysiloxane block. In some embodiments, the polycarbonate-polysiloxane comprises multiple polycarbonate blocks and multiple polysiloxane blocks. The at least one polycarbonate block comprises (aromatic) carbonate units of the formula

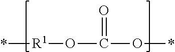

wherein at least 60 mole percent of the total number of R¹ groups are aromatic divalent groups. In some embodiments, the aromatic divalent groups are C₆-C₂₄ aromatic divalent groups. When not all R¹ groups are aromatic divalent groups, the remainder are C₂-C₂₄ aliphatic divalent groups. In some embodiments, each R¹ is a radical of the formula

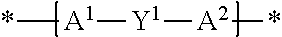

wherein each of A¹ and A² is independently a monocyclic divalent aryl radical, and Y¹ is a divalent radical in which one or two atoms separate A¹ from A². Examples of A¹ and A² include 1,3-phenylene and 1,4-phenylene, each optionally substituted with one, two, or three C₁-C₆ alkyl groups. In some embodiments, one atom separates A¹ from A². Examples of Y¹ are —O—, —S—, —S(O)—, —S(O)₂—, —C(O)—, methylene, cyclohexylmethylene, 2-[2.2.1]-bicycloheptylidene, ethylidene, isopropylidene, neopentylidene, cyclohexylidene, cyclododecylidene, cyclopentadecylidene, and adamantylidene. In some embodiments, Y¹ is a C₁-C₁₂ (divalent) hydrocarbylene group. As used herein, the term “hydrocarbyl”, whether used by itself, or as a prefix, suffix, or fragment of another term, refers to a residue that contains only carbon and hydrogen, unless it is specifically identified as “substituted hydrocarbyl.” The hydrocarbyl residue can be aliphatic or aromatic, straight-chain or cyclic or branched, and saturated or unsaturated. It can also contain combinations of aliphatic, aromatic, straight chain, cyclic, branched, saturated, and unsaturated hydrocarbon moieties. When the hydrocarbyl residue is described as substituted, it includes one or more substituents such as, for example, halogen (i.e., F, Cl, Br, I), hydroxyl, amino, thiol, carboxyl, carboxylate, amide, nitrile, sulfide, disulfide, nitro, C₁-C₁₈ alkyl, C₁-C₁₈ alkoxyl, C₆-C₁₈ aryl, C₆-C₁₈ aryloxyl, C₇-C₁₈ alkylaryl, or C₇-C₁₈ alkylaryloxyl. Specific examples of Y¹ include methylene (—CH₂—; also known as methylidene), ethylidene (—CH(CH₃)—), isopropylidene (—C(CH₃)₂—), and cyclohexylidene. In some embodiments, the divalent carbonate unit is free of alkoxyl substituents.

The at least one polysiloxane block comprises diorganosiloxane units of the formula

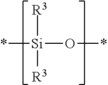

wherein each occurrence of R³ is independently C₁-C₁₄ hydrocarbyl. Examples of suitable hydrocarbyl groups include C₁-C₁₄ alkyl (including alkyl groups that are linear, branched, cyclic, or a combination of at least two of the foregoing), C₂-C₁₄ alkenyl, C₆-C₁₂ aryl, C₇-C₁₃ arylalkyl, and C₇-C₁₃ alkylaryl. The foregoing groups can be fully or partially halogenated with fluorine, chlorine, bromine, or iodine, or a combination thereof. In some embodiments, each occurrence of R⁷ is methyl. The at least one polysiloxane block can comprise 5 to 500 diorganosiloxane units. Within this range, the number of diorganosiloxane units can be 5 to 200, or 10 to 100.

In some embodiments, the at least one polysiloxane block has the formula

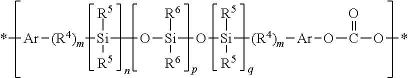

wherein Ar is independently at each occurrence a C₆-C₂₄ aromatic divalent group; R⁴ is independently at each occurrence a C₂-C₈ divalent aliphatic group; R⁵ and R⁶ are independently at each occurrence C₁-C₁₂ alkyl or C₆-C₁₈ aryl; m and n and q are independently at each occurrence zero or 1; and p is (30-n-q) to (60-n-q), or (35-n-q) to (55-n-q).

Examples of Ar groups include 1,3-phenylene, 1,4-phenylene, and 2,2-bis(4-phenylenyl)propane. When each occurrence of m, n, and q is zero, each occurrence of Ar can be derived from a C₆-C₂₄ dihydroxyarylene compound, such as, for example, resorcinol, 1,1-bis(4-hydroxyphenyl)methane, 1,1-bis(4-hydroxyphenyl)ethane, 1,1-bis(4-hydroxyphenyl)propane, 2,2-bis(4-hydroxyphenyl)propane, 1,1-bis(4-hydroxyphenyl)butane, 2,2-bis(4-hydroxyphenyl)butane, 2,2-bis(4-hydroxyphenyl)octane, 2,2-bis(4-hydroxy-3-methylphenyl)propane, 1,1-bis(4-hydroxyphenyl)cyclohexane, bis(4-hydroxyphenyl)sulfide, 2,2-bis(3,5-dibromo-4-hydroxyphenyl)propane, and 1,1-bis(4-hydroxy-3-t-butylphenyl)propane.

Examples of R⁴ groups include, for example, dimethylene (—(CH₂)₂—), trimethylene (—(CH₂)₃—), hexamethylene (—(CH₂)₆—), and 1,4-cyclohexylene. In some embodiments, each occurrence of R⁴ is trimethylene.

Examples of R⁵ and R⁶ groups include, for example, methyl, ethyl, 1-propyl, cyclohexyl, and phenyl. In some embodiments, each occurrence of R⁵ and R⁶ is methyl.

In some embodiments, each occurrence of m and n and q is zero. In other embodiments, each occurrence of m and n and q is 1. In some embodiments, p is (35-n-q) to (55-n-q).

In some embodiments, the at least one polysiloxane block has the formula

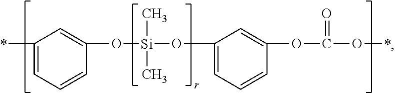

wherein r is 30 to 60, or 35 to 55.

In other embodiments, the at least one polysiloxane block has the formula

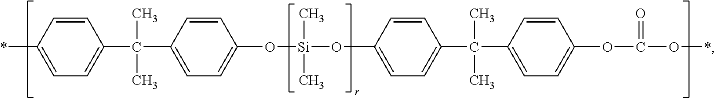

wherein r is 30 to 60, or 35 to 55.

In still other embodiments, the at least one polysiloxane block has the formula

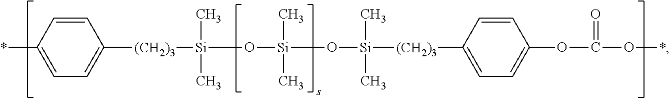

wherein s is 28 to 58, or 23 to 53.

In some embodiments, the polycarbonate-polysiloxane comprises, based on the weight of the polycarbonate-polysiloxane, 20 to 99 weight percent carbonate units and 1 to 80 weight percent diorganosiloxane units. Within the range of 20 to 99 weight percent, the carbonate unit content can be 50 to 98 weight percent, or 60 to 97 weight percent. Within the range of 1 to 80 weight percent, the diorganosiloxane content can be 2 to 50 weight percent, or 3 to 40 weight percent.

In some embodiments, the polycarbonate-polysiloxane comprises, based on the weight of the polycarbonate-polysiloxane, 70 to 97 weight percent carbonate units and 3 to 30 weight percent diorganosiloxane units. For example, the polycarbonate-polysiloxane can comprise 70 to 90 weight percent carbonate units and 10 to 30 weight percent diorganosiloxane units. Alternatively, the polycarbonate-polysiloxane can comprise 88 to 97 weight percent carbonate units and 3 to 12 weight percent diorganosiloxane units.

There is no particular limit on the structure of end groups on the polycarbonate-polysiloxane. An end-capping agent (also referred to as a chain stopping agent or chain terminating agent) can be included during polymerization to provide end groups. Examples of end-capping agents include monocyclic phenols such as phenol, p-cyanophenol, and C₁-C₂₂ alkyl-substituted phenols such as p-cumylphenol, resorcinol monobenzoate, and p-tertiary-butyl phenol; monoethers of diphenols, such as p-methoxyphenol; monoesters of diphenols such as resorcinol monobenzoate; functionalized chlorides of aliphatic monocarboxylic acids such as acryloyl chloride and methacryoyl chloride; and mono-chloroformates such as phenyl chloroformate, alkyl-substituted phenyl chloroformates, p-cumyl phenyl chloroformate, and toluene chloroformate. In some embodiments, the polycarbonate-polysiloxane is linear.

In some embodiments, the polycarbonate-polysiloxane has a weight average molecular weight of 5,000 to 50,000 grams/mole, specifically 10,000 to 40,000 grams/mole, as determined by gel permeation chromatography using bisphenol A polycarbonate standards. Polycarbonate-polysiloxanes and methods for their preparation are known and described, for example, in U.S. Pat. Nos. 3,419,634 and 3,419,635 to Vaughn, U.S. Pat. No. 3,821,325 to Merritt et al., U.S. Pat. No. 3,832,419 to Merritt, and U.S. Pat. No. 6,072,011 to Hoover.

The composition comprises the polycarbonate-polysiloxane in an amount of 10 to 99 weight percent, based on the total weight of the composition. Within this range, the polycarbonate-polysiloxane amount can be 20 to 98 weight percent, or 30 to 97 weight percent.

In some embodiments, the composition comprises the polycarbonate-polysiloxane in an amount effective to contribute 2 to 8 weight percent polysiloxane to the composition, based on the total weight of the composition. Within this range, the contributed amount of polysiloxane can be 2 to 7 weight percent, or 2 to 6 weight percent.

Polycarbonate-polysiloxanes and methods for their preparation are known and described, for example, in U.S. Pat. Nos. 3,419,634 and 3,419,635 to Vaughn, U.S. Pat. No. 3,821,325 to Merritt et al., U.S. Pat. No. 3,832,419 to Merritt, and U.S. Pat. No. 6,072,011 to Hoover.

In addition to the polycarbonate-polysiloxane, the composition comprises titanium dioxide-containing particles comprising a polysiloxane. As used herein, the term “titanium dioxide-containing particles” refers to particles comprising at least 90 weight percent titanium dioxide (TiO₂), based on the total weight of the titanium dioxide-containing particles. In some embodiments, the titanium dioxide content of the titanium dioxide-containing particles is 90 to 99.9 weight percent, or 92 to 99, or 94 to 98 weight percent.

The titanium-dioxide-containing particles comprise a polysiloxane. The polysiloxane is typically present as a layer at or near the surface of the titanium-dioxide-containing particles. Polysiloxanes include, for example, polymethylhydrogensiloxanes, polydimethylsiloxanes, polymethyl(C₂-C₁₄-alkyl)siloxanes, polymethylphenylsiloxanes, organically functionalized polysiloxanes, polysiloxanes functionalized with vinyl or alkoxyl or amino groups, and combinations thereof. In some embodiments, the polysiloxane comprises polymethylhydrogensiloxane, polydimethylsiloxane, or a combination thereof. The titanium-dioxide-containing particles comprise the polysiloxane in an amount of 0.1 to 10 weight percent, based on the total weight of the titanium dioxide-containing particles. Within this range, the polysiloxane content can be 0.2 to 6 weight percent, or 0.2 to 4 weight percent, or 0.2 to 2 weight percent. In some embodiments, the polysiloxane content is 0.5 to 10 weight percent. The polysiloxane content can also be expressed as the equivalent weight of elemental carbon. For example, when the polysiloxane is a polydimethylsiloxane, the titanium-dioxide-containing particles can comprise the polysiloxane in a carbon equivalent amount of 0.0324 to 3.24 weight percent, based on the total weight of the titanium dioxide-containing particles. Within this range, carbon equivalent polysiloxane content can be 0.0648 to 1.94 weight percent, or 0.0648 to 1.30 weight percent, or 0.0648 to 0.648 weight percent. In some embodiments, the carbon equivalent polysiloxane content is 0.162 to 3.24 weight percent.

The titanium dioxide-containing particles can, optionally, further comprise up to 6 weight percent of alumina (Al₂O₃), based on the total weight of the titanium dioxide-containing particles. Within this limit, the alumina content of the titanium dioxide-containing particles can be 0.1 to 6 weight percent, or 0.2 to 4 weight percent, or 0.5 to 4 weight percent. When present, alumina typically exists as a layer between the bulk of the titanium dioxide-containing particle and a layer comprising polysiloxane.

The titanium dioxide-containing particles can, optionally, further comprise up to 6 weight percent of silica (SiO₂), based on the total weight of the titanium dioxide-containing particles. Within this limit, the silica content of the titanium dioxide-containing particles can be 0.1 to 6 weight percent, or 0.2 to 4 weight percent, or 0.5 to 3 weight percent. In some embodiments, the titanium dioxide-containing particles comprise silica in an amount of 0 to 3 weight percent, or 0 to 2 weight percent, or 0 to 1 weight percent. When present, silica typically exists as a layer between the bulk of the titanium dioxide-rich particle and a layer comprising polysiloxane.

In some embodiments, the titanium dioxide-containing particles have a median equivalent spherical diameter of 0.1 to 0.4 micrometer, determined by laser diffraction according to ISO 13320:2009. Within this range, the median equivalent spherical diameter can be 0.1 to 0.3 micrometer, or 0.15 to 0.25 micrometer.

Polysiloxane-treated titanium dioxide particles and their preparation are described, for example, in U.S. Pat. No. 4,375,989 to Makinen, U.S. Pat. No. 5,562,990 to Tooley et al., and U.S. Pat. No. 7,579,391 B2 to Takahashi et al.; and U.S. Patent Application Publication Number US 2010/0125117 A1 of Drews-Nicolai et al.

In some embodiments, the composition comprises less than 2 weight percent of, or less than 1 weight percent of, or entirely excludes thermally insulating fillers selected from the group consisting of talc, calcium carbonate, magnesium hydroxide, mica, barium oxide, boehmite, diaspore, gibbsite, barium sulfate, zirconium oxide, silicon oxide, glass beads, glass fiber, magnesium aluminate, dolomite, ceramic-coated graphite, clay, and combinations thereof.

In addition to the polycarbonate-polysiloxane and the titanium dioxide-containing particles, the composition can, optionally, further comprise a polycarbonate. As used herein, the term “polycarbonate” refers to a polymer consisting essentially of carbonate units of the formula

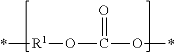

wherein at least 60 mole percent of the total number of R¹ groups are aromatic divalent groups. In some embodiments, the aromatic divalent groups are C₆-C₂₄ aromatic divalent groups. When not all R¹ groups are aromatic divalent groups, the remainder are C₂-C₂₄ aliphatic divalent groups. In some embodiments, each R¹ is a radical of the formula

* [symbol] A¹-Y¹-A² [symbol] *

wherein each of A¹ and A² is independently a monocyclic divalent aryl radical, and Y¹ is a divalent radical in which one or two atoms separate A¹ from A². Examples of A¹ and A² include 1,3-phenylene and 1,4-phenylene, each optionally substituted with one, two, or three C₁-C₆ alkyl groups. In some embodiments, one atom separates A¹ from A². Examples of Y¹ are —O—, —S—, —S(O)—, —S(O)₂—, —C(O)—, methylene, cyclohexylmethylene, 2-[2.2.1]-bicycloheptylidene, ethylidene, isopropylidene, neopentylidene, cyclohexylidene, cyclododecylidene, cyclopentadecylidene, and adamantylidene. In some embodiments, Y¹ is a C₁-C₁₂ (divalent) hydrocarbylene group. As used herein, the term “hydrocarbyl”, whether used by itself, or as a prefix, suffix, or fragment of another term, refers to a residue that contains only carbon and hydrogen, unless it is specifically identified as “substituted hydrocarbyl.” The hydrocarbyl residue can be aliphatic or aromatic, straight-chain or cyclic or branched, and saturated or unsaturated. It can also contain combinations of aliphatic, aromatic, straight chain, cyclic, branched, saturated, and unsaturated hydrocarbon moieties. When the hydrocarbyl residue is described as substituted, it includes one or more substituents such as, for example, halogen (i.e., F, Cl, Br, I), hydroxyl, amino, thiol, carboxyl, carboxylate, amide, nitrile, sulfide, disulfide, nitro, C₁-C₁₅ alkyl, C₁-C₁₅ alkoxyl, C₆-C₁₈ aryl, C₆-C₁₈ aryloxyl, C₇-C₁₈ alkylaryl, or C₇-C₁₈ alkylaryloxyl. Specific examples of Y¹ include methylene (—CH₂—; also known as methylidene), ethylidene (—CH(CH₃)—), isopropylidene (—C(CH₃)₂—), and cyclohexylidene. In some embodiments, the divalent carbonate unit is free of alkoxyl substituents. In some embodiments, the polycarbonate is a bisphenol A polycarbonate, i.e., R¹ is a radical of the formula

* [symbol] A¹-Y¹-A² [symbol] *,

A¹ and A² are 1,4-phenylene, and Y¹ is isopropylidene.

There is no particular limit on the structure of end groups on the polycarbonate. An end-capping agent (also referred to as a chain stopping agent or chain terminating agent) can be included during polymerization to provide end groups. Examples of end-capping agents include monocyclic phenols such as phenol, p-cyanophenol, and C₁-C₂₂ alkyl-substituted phenols such as p-cumylphenol, resorcinol monobenzoate, and p-tertiary-butyl phenol; monoethers of diphenols, such as p-methoxyphenol; monoesters of diphenols such as resorcinol monobenzoate; functionalized chlorides of aliphatic monocarboxylic acids such as acryloyl chloride and methacryoyl chloride; and mono-chloroformates such as phenyl chloroformate, alkyl-substituted phenyl chloroformates, p-cumyl phenyl chloroformate, and toluene chloroformate. In some embodiments, the polycarbonate is linear.

In some embodiments, the polycarbonate-polysiloxane comprises bisphenol A carbonate units, the composition further comprises a bisphenol A polycarbonate, and the polycarbonate-polysiloxane and the bisphenol A polycarbonate collectively contribute 84 to 97 weight percent bisphenol A carbonate units to the composition, based on the total weight of the composition. In some embodiments, the composition comprises less than 5 weight percent, or less than 3 weight percent, or less than 1 weight percent of any polymer other than the polycarbonate-polysiloxane and the optional polycarbonate.

The composition can, optionally, further comprise one or more additives known in the thermoplastics art. For example, the composition can, optionally, further comprise an additive selected from the group consisting of stabilizers, mold release agents, lubricants, processing aids, drip retardants, nucleating agents, UV blockers, colorants other than the titanium dioxide-containing particles (including dyes and pigments), antioxidants, anti-static agents, metal deactivators, and combinations thereof. When present, such additives are typically used in a total amount of less than or equal to 10 weight percent, or less than or equal to 5 weight percent, or less than or equal to 1 weight percent, based on the total weight of the composition.

In some embodiments, the composition comprises less than 2 weight percent of, or less than 1 weight percent of, or entirely excludes phosphorus-containing flame retardants selected from the group consisting of aromatic phosphate flame retardants (including monomeric, oligomeric, and polymeric types), aromatic polyphosphate flame retardants, phosphonate flame retardants (including monomeric, oligomeric, and polymeric types), nixed phosphate/phosphonate ester flame retardants, phenoxyphosphazene flame retardants (including monomeric, oligomeric, and polymeric types), mixed phosphate/phosphonate ester flame retardants, and combinations thereof.

In some embodiments, the composition comprises less than 1 weight percent of or excludes polycarbonates having a glass transition temperature greater than or equal to 155° C., determined by differential scanning calorimetry according to ASTM D3418-15 at a heating rate of 20° C./minute. In some embodiments, the composition comprises less than 1 weight percent of or excludes polyestercarbonates. In some embodiments, the composition comprises less than 1 weight percent of or excludes polyestercarbonate-polysiloxanes. In some embodiments, the composition comprises less than 1 weight percent of or excludes polyetherimides. In some embodiments, the composition comprises less than 1 weight percent of or excludes polyetherimide polysiloxanes. In some embodiments, the composition comprises less than 1 weight percent of or excludes any two or more of polycarbonates having a glass transition temperature greater than or equal to 155° C. determined by differential scanning calorimetry according to ASTM D3418-15 at a heating rate of 20° C./minute, polyestercarbonates, polyestercarbonate-polysiloxanes, polyetherimides, and poly etherimide pols siloxanes. In some embodiments, the composition comprises less than 1 weight percent of or excludes polycarbonates having a glass transition temperature greater than or equal to 155° C. determined by differential scanning calorimetry according to ASTM D3418-15 at a heating rate of 20° C./minute, polyestercarbonates, poly estercarbonate-poly siloxanes, polyetherimides, and polyetherimide polysiloxanes.

In a very specific embodiment of the method, the composition comprises 1.5 to 6 weight percent of the titanium dioxide-containing particles, the polycarbonate-polysiloxane contributes 2 to 6 weight percent of polysiloxane to the composition, the composition optionally further comprises a bisphenol A polycarbonate, and the polycarbonate-polysiloxane and the optional bisphenol A polycarbonate collectively contribute 84 to 96.5 weight percent bisphenol A carbonate units to the composition.

Another embodiment is an article additively manufactured in a ZX orientation, the article comprising: at least two contiguous layers; wherein the at least two contiguous layers comprise a composition comprising, based on the total weight of the composition, 10 to 99 weight percent of a polycarbonate-polysiloxane; and 1 to 7.5 weight percent of titanium dioxide-containing particles comprising a polysiloxane.

One advantage of the present invention is that it provides improved impact strength in the Z-direction. Thus, in some embodiments, the additively manufactured article is prepared by fused filament fabrication; and the additively manufactured article exhibits a notched Izod impact strength value 10 to 50 percent greater than a notched Izod impact strength value of a comparative additively manufactured article prepared from a corresponding composition lacking the titanium dioxide-containing particles, wherein notched Izod impact strength is determined according to ASTM D256-10(2018) at 23° C. Within the range of 10 to 50 percent, the improvement of notched Izod impact strength can be 20 to 50 percent.

In some embodiments of the article, the polycarbonate-polysiloxane contributes 2 to 8 weight percent, or 2 to 6 weight percent polysiloxane to the composition.

In some embodiments of the article, the composition optionally further comprises a bisphenol A polycarbonate; and the polycarbonate-polysiloxane and the optional bisphenol A polycarbonate collectively contribute 84 to 97 weight percent bisphenol A carbonate units to the composition.

In some embodiments of the article, the titanium dioxide-containing particles have a median equivalent spherical diameter of 0.1 to 0.4 micrometer, determined by laser diffraction according to ISO 13320:2009. Within this range, the median equivalent spherical diameter of the titanium dioxide-containing particles can be 0.1 to 0.3 micrometer, or 0.15 to 0.25 micrometer.

In a very specific embodiment of the article, the composition comprises 1.5 to 6 weight percent of the titanium dioxide-containing particles; the polycarbonate-polysiloxane contributes 2 to 6 weight percent of polysiloxane to the composition; the composition optionally further comprises a bisphenol A polycarbonate; and the polycarbonate-polysiloxane and the optional bisphenol A polycarbonate collectively contribute 84 to 96.5 weight percent bisphenol A carbonate units to the composition.

All ranges disclosed herein are inclusive of the endpoints, and the endpoints are independently combinable with each other. Each range disclosed herein constitutes a disclosure of any point or sub-range lying within the disclosed range.

The invention includes at least the following aspects.

Aspect 1: A method of additively manufacturing an article in a ZX orientation, the method comprising: converting a composition from a solid form to a molten form; extruding the molten form to form a first molten extrusion; depositing the first molten extrusion in a predetermined pattern to form a first layer; further extruding the molten form to form a second molten extrusion; and depositing the second molten extrusion in a predetermined pattern to form a second layer having a lower surface in contact with an upper surface of the first layer; wherein the composition comprises, based on the total weight of the composition, 10 to 99 weight percent of a polycarbonate-polysiloxane; and 1 to 7.5 weight percent of titanium dioxide-containing particles comprising a polysiloxane.

Aspect 2: The method of aspect 1, wherein the polycarbonate-polysiloxane contributes 2 to 8 weight percent polysiloxane to the composition.

Aspect 3: The method of aspect 1 or 2, wherein the composition optionally further comprises a bisphenol A polycarbonate; and wherein the polycarbonate-polysiloxane and the optional bisphenol A polycarbonate collectively contribute 84 to 97 weight percent bisphenol A carbonate units to the composition.

Aspect 4: The method of any one of aspects 1-3, wherein the titanium dioxide-containing particles have a median equivalent spherical diameter of 0.1 to 0.4 micrometer, determined by laser diffraction according to ISO 13320:2009.

Aspect 5: The method of aspect 1, wherein the composition comprises 1.5 to 6 weight percent of the titanium dioxide-containing particles; wherein the polycarbonate-polysiloxane contributes 2 to 6 weight percent of polysiloxane to the composition; wherein the composition optionally further comprises a bisphenol A polycarbonate; and wherein the polycarbonate-polysiloxane and the optional bisphenol A polycarbonate collectively contribute 84 to 96.5 weight percent bisphenol A carbonate units to the composition.

Aspect 6: An article additively manufactured in a ZX orientation, the article comprising: at least two contiguous layers; wherein the at least two contiguous layers comprise a composition comprising, based on the total weight of the composition, 10 to 99 weight percent of a polycarbonate-polysiloxane; and 1 to 7.5 weight percent of titanium dioxide-containing particles comprising a polysiloxane.

Aspect 7: The additively manufactured article of aspect 6, wherein the additively manufactured article is prepared by fused filament fabrication; and wherein the additively manufactured article exhibits a notched Izod impact strength value 10 to 50 percent greater than a notched Izod impact strength value of a comparative additively manufactured article prepared from a corresponding composition lacking the titanium dioxide-containing particles, wherein notched Izod impact strength is determined according to ASTM D256-10(2018) at 23° C.

Aspect 8: The additively manufactured article of aspect 6 or 7, wherein the polycarbonate-polysiloxane contributes 2 to 8 weight percent polysiloxane to the composition.

Aspect 9: The additively manufactured article of any one of aspects 6-8, wherein the composition optionally further comprises a bisphenol A polycarbonate; and wherein the polycarbonate-polysiloxane and the optional bisphenol A polycarbonate collectively contribute 84 to 97 weight percent bisphenol A carbonate units to the composition.

Aspect 10: The additively manufactured article of any one of aspects 6-9, wherein the titanium dioxide-containing particles have a median equivalent spherical diameter of 0.1 to 0.4 micrometer, determined by laser diffraction according to ISO 13320:2009.

Aspect 11: The additively manufactured article of aspect 6, wherein the composition comprises 1.5 to 6 weight percent of the titanium dioxide-containing particles; wherein the poly carbonate-polysiloxane contributes 2 to 6 weight percent of polysiloxane to the composition; wherein the composition optionally further comprises a bisphenol A polycarbonate; and wherein the polycarbonate-polysiloxane and the optional bisphenol A polycarbonate collectively contribute 84 to 96.5 weight percent bisphenol A carbonate units to the composition.

The invention is further illustrated by the following non-limiting examples.

### Examples

Materials used in these experiments are summarized in Table 1. Compositions are summarized in Tables 2-4, where component amounts are expressed in weight percent based on the total weight of the composition.

TABLE 1

| Material | Description |
|---|---|
| PC-Si | para-Cumylphenol-endcapped polycarbonate-polysiloxane, comprising |
| | polycarbonate blocks containing bisphenol A carbonate units and |
| | polysiloxane blocks containing dimethylsiloxane units, the polysiloxane |
| | blocks having an average of about 45 dimethylsiloxane units per block; |
| | the polycarbonate-polysiloxane having a weight average molecular weight |
| | of about 23,000 grams/mole based on bisphenol A polycarbonate |
| | standards, and a polysiloxane content of about 6 weight percent; |
| | preparable according to the procedure of paragraphs [0061] to [0064] of |
| | International Patent Application Publication No. WO 2017/019969 A1 of |
| | Hoover et al. |
| BPAPC 1 | para-Cumylphenol-endcapped bisphenol A polycarbonate having a weight |
| | average molecular weight of about 21,900 grams/mole based on bisphenol |
| | A polycarbonate standards. |
| BPAPC 2 | para-Cumylphenol-endcapped bisphenol A polycarbonate having a weight |
| | average molecular weight of about 29,900 grams/mole based on bisphenol |
| | A polycarbonate standards. |
| TiO₂ 1 | Titanium dioxide-containing particles, surface treated with aluminum and |
| | polysiloxane compounds, having a titanium dioxide content ≥96 weight |
| | percent; obtained as KRONOS 2233 titanium dioxide from Kronos |
| | Worldwide Inc. |
| TiO₂ 2 | Titanium dioxide-containing particles, having a titanium dioxide content |
| | ≥97 weight percent, an alumina content ≤1.7 weight percent, and no |
| | polysiloxane; obtained as Ti-Pure ™ R-104 from Chemours. |
| TiO₂ 3 | Titanium dioxide-containing particles; prepared by polysiloxane surface |
| | treatment of Ti-Pure ™ R-960 titanium dioxide obtained from Chemours |
| | (prior to surface treatment with polysiloxane, Ti-Pure ™ R-960 has |
| | a titanium dioxide content ≥90%, an alumina content of 3.3%, and an |
| | amorphous silica content of 5.5%). |
| Stab. 1 | Phosphorous acid, CAS Reg. No. 13598-36-2, 0.15 weight percent |
| | solution in water. |
| Stab. 2 | tris(2,4-di-tert-Butylphenyl)phosphite, CAS Reg. No. 31570-04-4; |
| | obtained as IRGAFOS ™ 168 from BASF. |
| Stab. 3 | 2-Methyl-2,4-pentanediol, CAS Reg. No. 107-41-5; obtained from |
| | Brenntag. |
| Pigment Blue 60 | Pigment Blue 60, CAS Reg. No. 81-77-6. |
| Solvent Blue 104 | Solvent Blue 104, CAS Reg. No. 116-75-6. |
| Solvent Blue 104 | Solvent Blue 104, CAS Reg. No. 116-75-6; 1 weight percent masterbatch |
| MB | in bisphenol A polycarbonate. |
| Solvent Violet 36 | Solvent Violet 36, CAS Reg. No. 61951-89-1. |
| Solvent Red 135 | Solvent Red 135, CAS Reg. No. 20749-68-2; 1 weight percent |
| MB | masterbatch in bisphenol A polycarbonate. |
| Disperse Orange | CAS Reg. No. 12236-03-2; 1 weight percent masterbatch in bisphenol A |
| 47 MB | polycarbonate. |
| CB | Carbon black, CAS Reg. No. 1333-86-4. |
| CB MB | Carbon black, CAS Reg. No. 1333-86-4; 1 weight percent masterbatch in |
| | bisphenol A polycarbonate, |
| PETS | Pentaerythritol tetrastearate, CAS Reg. No. 115-83-3. |

Compositions were compounded on a 25 millimeter Werner-Pfleiderer ZAK twin-screw extruder having a length to diameter ratio of 33:1 and a vacuum port located upstream of the die face, and operating at barrel temperatures of 280-295° C./280-295° C./285-300° C./290-305° C./295-310° C./300-315° C./305-320° C. from feed throat to die, a die temperature of 305-320° C., and a throughput of 15-25 kilograms/hour. All components were added at the feed throat. The extrudate was cooled in a water bath, then pelletized. Pellets were dried in a vacuum oven at 135° C. for at least four hours before use.

Test articles for flammability testing and physical property determination were prepared by both injection molding and additive manufacturing. Injection molding utilized a Sumitomo 180-ton DEMAG™ molding machine operating at a barrel temperature of 300-330° C., a mold temperature of 110-140° C., a screw speed of 40-70 rotations per minute, a back pressure of 0.3-0.7 megapascals, and a shot-to-cylinder size of 40-60%. All injection molded test articles were conditioned at 23° C. and 50% relative humidity for at least one day before testing.

Fused filament fabrication was used to directly print tensile bars having dimensions according to ASTM D638-14, and Izod bars having dimensions according to ASTM D256-10e1. For each composition, pellets were extruded into monofilaments about 1.79-1.8 millimeters in diameter. The spooled filaments were dried to less than 0.04 weight percent moisture before use for fused filament fabrication in a Stratasys FORTUS 400mc or 900mc printer under standard polycarbonate conditions with a nozzle/print head temperature of 345° C. and a chamber temperature of 145° C. using a tip size of 0.254 millimeter (0.010 inch; T16;), a layer thickness (resolution) of 0.254 millimeter (0.010 inch), a contour and raster width of 0.508 millimeter (0.020 inch), a precision of the greater of +/−0.127 millimeters (+/−0.005 inch) or +/−0.0015 millimeter/millimeter (+/−0.0015 inch/inch), and an air gap of 0.0000 millimeter (0.0000 inch). Test parts were directly printed (rather than being cut from a larger object) by printing alternating layers in +45/−45 degree criss-cross orientations. In this configuration, strands of extrudate were laid in a diagonal pattern with each layer crossing over at a 90 degree angle from the previous layer. Upright, on-edge, and flat printing orientations were all used in this experiment.

Melt flow rate (MFR) values, expressed in units of grams per 10 minutes, were determined according to ASTM D1238-13 at a temperature of 300° C. and a load of 1.2 kilograms. Glass transition temperature (T_{g}) values, expressed in units of degrees centigrade, were determined according to ASTM D3418-15 by differential scanning calorimetry using a temperature range of 40 to 250° C. and a heating rate of 20° C./minute.

Tensile modulus values (expressed in units of megapascals), tensile strength at break (expressed in units of megapascals), and tensile elongation (expressed in units of percent) were determined at 23° C. according to ASTM D638-14. Notched Izod impact strength values, expressed in units of joules/meter, were determined at 23° C. according to ASTM D256-10e1. Unnotched Izod impact strength values, expressed in units of joules/meter, were determined at 23° C. according to ASTM D4812-19. Flexural modulus values, expressed in units of megapascals, were determined at 23° C. according to ASTM D790-17.

The results in Table 2 show that for test articles printed in the upright orientation, the Example 1 composition containing 1.96 weight percent TiO₂ 1 exhibited a greater notched Izod impact strength (79 joules/meter) than Comparative Example 1 with no titanium dioxide (57 joules/meter), and Comparative Example 2 with 0.204 weight percent TiO₂ 1 (45 joules/meter). Also for test articles printed in the upright orientation, Comparative Example 3 with 0.87 weight percent carbon black exhibited lower notched Izod impact strength (38 joules/meter) than Comparative Example 1 with no colorant (57 joules/meter). The increase in notched Izod impact strength for Example 1 (1.96% TiO₂ 1) versus Comparative Example 2 (no colorant) was not observed for articles printed in flat and on-edge orientations.

TABLE 2

| | C. Ex. 1 | Ex. 1 | C. Ex. 2 | C. Ex. 3 |
|---|---|---|---|---|
| COMPOSITIONS | | | | |
| BPAPC 1 | 6.00 | 5.869 | 5.98 | 5.95 |
| BPAPC 2 | 10.87 | 10.6484 | 10.85 | 10.78 |
| PC-Si | 83.00 | 81.3566 | 82.83 | 82.27 |
| Stab. 1 | 0.099 | 0.099 | 0.099 | 0.099 |
| Stab. 2 | 0.027 | 0.027 | 0.027 | 0.027 |
| Pigment Blue 60 | 0.00013 | 0 | 0 | 0 |
| Solvent Violet 36 | 0.00012 | 0 | 0 | 0 |
| TiO₂ 1 | 0 | 2.00 | 0.204 | 0 |
| Solvent Blue 104 | 0 | 0 | 0.000107 | 0 |
| CB MB | 0 | 0 | 0 | 0.87 |

PROPERTIES
Thermal and Rheological Properties

| | | | | |
|---|---|---|---|---|
| MFR, 300° C., 1.2 kg (g/10 min) | — | 10 | 10 | 9 |
| T_{g} (° C) | — | 147 | 148 | 148 |

Properties of Injection Molded Articles

| | | | | |
|---|---|---|---|---|
| Tensile modulus (MPa) | — | 60 | 60 | 57 |
| Tensile strength at break (MPa) | — | 127 | 126 | 120 |
| Tensile elongation at break (%) | — | 734 | 782 | 782 |
| Notched Izod impact strength (J/m) | — | 2042 | 2068 | 2062 |

Properties of Additively Manufactured Articles

| | | | | |
|---|---|---|---|---|
| Notched Izod impact strength (J/m) | | | | |
| flat | 204 | 195 | 209 | 200 |
| on-edge | 297 | 220 | 264 | 254 |
| upright | 57 | 79 | 45 | 38 |
| Unnotched Izod impact strength (J/m) | | | | |
| flat | 832 | 726 | 796 | 688 |
| on-edge | 695 | 487 | 623 | 577 |
| upright | 226 | 271 | 213 | 194 |
| Tensile modulus (MPa) | | | | |
| flat | 1776 | 1520 | 1548 | 1630 |
| on-edge | 1921 | 1898 | 1876 | 1914 |
| upright | 1770 | 1703 | 1746 | 1804 |
| Tensile strength at break (MPa) | | | | |
| flat | 46 | 39 | 40 | 42 |
| on-edge | 53 | 45 | 45 | 50 |
| upright | 38 | 38 | 39 | 38 |
| Tensile elongation at break (%) | | | | |
| flat | 6 | 5.9 | 5.8 | 5.7 |
| on-edge | 5 | 4.1 | 4.0 | 4.3 |
| upright | 3 | 2.9 | 3.0 | 2.7 |
| Flexural modulus (MPa) | | | | |
| flat | 1475 | 1370 | 1380 | 1440 |
| on-edge | 1955 | 1860 | 1820 | 1880 |
| upright | 1571 | 1470 | 1500 | 1550 |

Additional compositions were prepared to explore the effects of titanium dioxide type and concentration. The results in Table 3 show that for test articles printed in the upright orientation, notched Izod impact strength values were greater for Examples 2, 3, and 4 with 2, 5, and 7.5 weight percent TiO₂ 1, respectively (79, 79, and 80 joules/meter), than for Comparative Example 4 with 0.2 weight percent TiO₂ 1 (47 joules/meter). An increase in upright orientation notched Izod impact strength was also observed for Example 5 with 2 weight percent of poly siloxane-coated TiO₂ 3 relative to Comparative Example 2 with no colorant (57 joules/meter). In contrast, the upright orientation notched Izod impact strength for Comparative Example 6 with 2 weight percent TiO₂ 2 having no polysiloxane coating (51 joules/meter) was worse than that of Comparative Example 2 with no titanium dioxide (57 joules/meter).

TABLE 3

| | | | | | |
|---|---|---|---|---|---|
| C. Ex. 4 | Ex. 2 | Ex. 3 | Ex. 4 | C. Ex. 5 | Ex. 5 |

COMPOSITIONS

| | | | | | | |
|---|---|---|---|---|---|---|
| BPAPC 1 | 5.984 | 5.869 | 5.654 | 5.538 | 5.869 | 5.869 |
| BPAPC 2 | 10.855 | 10.6484 | 10.22 | 10.0585 | 10.6484 | 10.6484 |
| PC-Si | 82.835 | 81.3566 | 79.00 | 76.7775 | 81.3566 | 81.3566 |
| Stab. 1 | 0.099 | 0.099 | 0.099 | 0.099 | 0.099 | 0.099 |
| Stab. 2 | 0.027 | 0.027 | 0.027 | 0.027 | 0.027 | 0.027 |
| TiO₂ 1 | 0.2 | 2 | 5 | 7.5 | 0 | 0 |
| TiO₂ 2 | 0 | 0 | 0 | 0 | 2 | 0 |
| TiO₂ 3 | 0 | 0 | 0 | 0 | 0 | 2 |

PROPERTIES
Thermal and Rheological Properties

| | | | | | | |
|---|---|---|---|---|---|---|
| MFR, 300° C., 1.2 kg | 13 | 9 | 9 | 9 | 11 | 9 |
| (g/10 min) | | | | | | |
| T_{g} (° C.) | 146 | 148 | 147 | 148 | 148 | 148 |

Properties of Injection Molded Articles

| | | | | | | |
|---|---|---|---|---|---|---|
| Tensile modulus | 2054 | 2030 | 2010 | 1988 | 2028 | 2028 |
| (MPa) | | | | | | |
| Tensile strength at | 57 | 57 | 57 | 52 | 55 | 57 |
| break (MPa) | | | | | | |
| Tensile elongation at | 110 | 112 | 111 | 107 | 109 | 112 |
| break (%) | | | | | | |
| Notched Izod impact | 848 | 770 | 722 | 675 | 789 | 782 |
| strength (J/m) | | | | | | |

Properties of Additively Manufactured Articles
Notched Izod impact strength (J/m)

| | | | | | | |
|---|---|---|---|---|---|---|
| flat | 170 | 195 | 208 | 222 | 205 | 207 |
| on-edge | 224 | 220 | 241 | 175 | 219 | 213 |
| upright | 47 | 79 | 79 | 80 | 51 | 65 |

Unmotched Izod impact strength (J/m)

| | | | | | | |
|---|---|---|---|---|---|---|
| flat | 750 | 726 | 834 | 769 | 815 | 803 |
| on-edge | 565 | 487 | 550 | 456 | 539 | 537 |
| upright | 329 | 271 | 311 | 323 | 347 | 314 |

Tensile modulus (MPa)

| | | | | | | |
|---|---|---|---|---|---|---|
| flat | 1503 | 1520 | 1483 | 1320 | 1493 | 1437 |
| on-edge | 1740 | 1898 | 1697 | 1630 | 1753 | 1663 |
| upright | 1856 | 1703 | 1837 | 1750 | 1947 | 1673 |

Tensile strength at break (MPa)

| | | | | | | |
|---|---|---|---|---|---|---|
| flat | 42 | 39 | 40 | 36 | 41 | 39 |
| on-edge | 48 | 45 | 43 | 39 | 46 | 45 |
| upright | 44 | 38 | 44 | 40 | 45 | 45 |

Tensile elongation at break (%)

| | | | | | | |
|---|---|---|---|---|---|---|
| flat | 6.7 | 5.9 | 7.0 | 5.6 | 7.9 | 6.2 |
| on-edge | 4.6 | 4.1 | 4.4 | 4.1 | 4.3 | 4.5 |
| upright | 3.5 | 2.9 | 3.5 | 3.1 | 3.5 | 3.6 |

The effect of polysiloxane-coated TiO₂ 1 in a blend of two bisphenol A polycarbonates was investigated in Comparative Examples 6 (1.47% TiO₂ 1) and 7 (0.15% TiO₂ 1) in Table 4, below. Upright notched Izod impact strength was not improved when the TiO₂ 1 loading was increased from 0.15 to 1.47%.

TABLE 4

| | |
|---|---|
| C. Ex. 6 | C. Ex. 7 |

COMPOSITIONS

| | | |
|---|---|---|
| BPAPC 1 | 88.25 | 89.54 |
| BPAPC 2 | 9.85 | 9.99 |
| Stab. 2 | 0.03 | 0.06 |
| PETS | 0.27 | 0.27 |
| Stab. 3 | 0.09 | 0 |
| TiO₂ 1 | 1.47 | 0.15 |
| Solvent Red 135 MB | 0.03 | 0 |
| Disperse Orange 47 MB | 0.00001 | 0 |
| Solvent Blue 104 MB | 0.024 | 0 |
| CB MB | 0.0001 | 0 |
| CB | 0 | 0.0000499 |
| Solvent Violet 36 | 0 | 0.00003 |
| Solvent Blue 104 | 0 | 0.0000499 |

PROPERTIES
Notched Izod impact strength (J/m)

| | | |
|---|---|---|
| flat | 36 | 49 |
| on-edge | 55 | 51 |
| upright | 27 | 27 |

1. A method of additively manufacturing an article in a ZX orientation, the method comprising:
converting a composition from a solid form to a molten form;
extruding the molten form to form a first molten extrusion;
depositing the first molten extrusion in a predetermined pattern to form a first layer;
further extruding the molten form to form a second molten extrusion; and
depositing the second molten extrusion in a predetermined pattern to form a second layer having a lower surface in contact with an upper surface of the first layer;
wherein the composition comprises, based on the total weight of the composition,
10 to 99 weight percent of a polycarbonate-polysiloxane; and
1 to 7.5 weight percent of titanium dioxide-containing particles comprising a polysiloxane.

2. The method of claim 1, wherein the polycarbonate-polysiloxane contributes 2 to 8 weight percent polysiloxane to the composition.

3. The method of claim 1,
wherein the composition optionally further comprises a bisphenol A polycarbonate; and
wherein the poly carbonate-polysiloxane and the optional bisphenol A polycarbonate collectively contribute 84 to 97 weight percent bisphenol A carbonate units to the composition.

4. The method of claim 1, wherein the titanium dioxide-containing particles have a median equivalent spherical diameter of 0.1 to 0.4 micrometer, determined by laser diffraction according to ISO 13320:2009.

5. The method of claim 1,
wherein the composition comprises 1.5 to 6 weight percent of the titanium dioxide-containing particles;
wherein the poly carbonate-polysiloxane contributes 2 to 6 weight percent of polysiloxane to the composition;
wherein the composition optionally further comprises a bisphenol A polycarbonate; and
wherein the poly carbonate-polysiloxane and the optional bisphenol A polycarbonate collectively contribute 84 to 96.5 weight percent bisphenol A carbonate units to the composition.

6. An article additively manufactured in a ZX orientation, the article comprising:
at least two contiguous layers;
wherein the at least two contiguous layers comprise a composition comprising, based on the total weight of the composition,
10 to 99 weight percent of a polycarbonate-polysiloxane; and
1 to 7.5 weight percent of titanium dioxide-containing particles comprising a polysiloxane.

7. The additively manufactured article of claim 6,
wherein the additively manufactured article is prepared by fused filament fabrication; and
wherein the additively manufactured article exhibits a notched Izod impact strength value 10 to 50 percent greater than a notched Izod impact strength value of a comparative additively manufactured article prepared from a corresponding composition lacking the titanium dioxide-containing particles, wherein notched Izod impact strength is determined according to ASTM D256-10(2018) at 23° C.

8. The additively manufactured article of claim 6, wherein the polycarbonate-polysiloxane contributes 2 to 8 weight percent polysiloxane to the composition.

9. The additively manufactured article of claim 6,
wherein the composition optionally further comprises a bisphenol A polycarbonate; and
wherein the poly carbonate-polysiloxane and the optional bisphenol A polycarbonate collectively contribute 84 to 97 weight percent bisphenol A carbonate units to the composition.

10. The additively manufactured article of claim 6, wherein the titanium dioxide-containing particles have a median equivalent spherical diameter of 0.1 to 0.4 micrometer, determined by laser diffraction according to ISO 13320:2009.

11. The additively manufactured article of claim 6,
wherein the composition comprises 1.5 to 6 weight percent of the titanium dioxide-containing particles;
wherein the poly carbonate-polysiloxane contributes 2 to 6 weight percent of polysiloxane to the composition;
wherein the composition optionally further comprises a bisphenol A polycarbonate; and
wherein the poly carbonate-polysiloxane and the optional bisphenol A polycarbonate collectively contribute 84 to 96.5 weight percent bisphenol A carbonate units to the composition.
